(19) United States
(12) Patent Application Publication
(10) Pub. No.: US 2008/0038499 A1
(43) Pub. Date: Feb. 14, 2008

(54) Water pipe for automobiles

(75) Inventors: Satoru Ono, Aichi-ken (JP); Yoshiaki Kameda, Aichi-ken (JP); Tsugunori Kashimura, Tokyo (JP); Takashi Yamashita, Tsukuba-shi (JP); Hideaki Takeda, Tsukuba-shi (JP)

Correspondence Address: POSZ LAW GROUP, PLC, 12040 SOUTH LAKES DRIVE, SUITE 101, RESTON, VA, 20191, US

(73) Assignees: TOYODA GOSEI CO., LTD., Aichi-ken (JP); KURARAY CO., LTD., Okayama (JP)

(21) Appl. No.: 11/890,531

(22) Filed: Aug. 7, 2007

(30) Foreign Application Priority Data
Aug. 9, 2006 (JP) 2006-217538

(51) Int. Cl. B32B 1/08

(52) U.S. Cl. 428/36.9

(57) ABSTRACT

All of hydrolysis resistance, heat resistance and calcium chloride resistance as the characteristics required during use are satisfied and the moldability as the characteristic required during molding is also ensured. Further, corrugation moldability, pressure proofness, bendability and shape retainability are ensured while enabling to adopt a mono-layer structure. A water pipe for use in automobiles molded with a thermoplastic polymer composition mainly comprising a polyamide resin (I) and a polyolefin (II), in which the polyamide resin (I) is a specified polyamide 9T; the amount of terminal amino groups of the polyamide resin (I) is 60 μmol/g or more and the amount of terminal carboxyl groups of the polyamide resin (I) is 10 μmol/g or less; the polyolefin (II) contains an acid modified polyolefin and the not acid-modified polyolefin at a mass ratio of from 80:20 to 20:80 and, as a result, the amount of the acid modification is from 0.2 to 0.5 mass %; and the mass ratio of (I) and (II) is from 90:10 to 70:30.

### BACKGROUND OF THE INVENTION

1. Field of the Invention

The present invention concerns a water pipe for automobiles in which an anti-freezing solution passes.

2. Related Art

An automobile is provided with a circulation device for an anti-freezing solution comprising a water jacket for an internal combustion engine for circulating the antifreezing solution, a radiator for cooling the anti-freezing solution, a water pump for pumping the anti-freezing solution, a thermostat for preventing overcooling of the anti-freezing solution and a heater core for warming a car chamber by the heat of the anti-freezing solution, and each of the portions described above is connected by a water pipe in which the anti-freezing solution passes (including inlet pipe and outlet pipe).

Many characteristics in use are required for the water pipe for use in automobiles and, particularly, the following characteristics are considered important.
1. Hydrolysis resistance: resistance to an anti-freezing solution usually used as a cooling water (typically, long life coolant).
2. Heat resistance: resistance to high temperature since it is piped near a heater core or an internal combustion engine.
3. Calcium chloride Resistance: resistance to calcium chloride usually used as a snow melting agent scattered on roads.

Since all of the characteristics described above cannot be satisfied with a single material, water pipes of a multi-layer structure using lamination of plural materials excellent in respective characteristics exemplified below have been predominant.

### Example 1

A water pipe of a three-layer structure comprising an inner pipe formed of polyphenylene sulfide (PPS) excellent in the hydrolysis resistance, an outer sheath formed of polyamide 6 of excellent heat resistance and an intermediate layer formed of a blend material of PPS and polyamide 6.

### Example 2

A water pipe of a three-layer structure comprising an inner pipe formed of PPS of excellent hydrolysis resistance, an outer sheath formed of polyamide 66 of excellent heat resistance and calcium chloride resistance and an intermediate layer formed of a blend material of PPS and a polyamide (JP-A No. 2005-306950).

However, water pipes have been designed as complicate shapes in recent years in view of the problem of layout in relation with other parts and corrugate pipes corrugated in a bellows shape easy for the bendability have been required. However, in a case where a water pipe of the plural layer structure described above is corrugated, since it involves a problem that a uniform thickness cannot be ensured easily for the bellows portion, the inter-layer adhesion strength is lowered and the pressure resistance is lowered, the pipe cannot actually be corrugated. Further, in a case of putting the water pipe of the plural layer structure to bending work, since the heating temperature upon bending work depends on a material of lower melting point among the materials of the plural layers, residual strains are left after bending work to also result in a problem that the shape of products cannot be retained but changed during storage and transportation thereof.

Further, JP-A No. 2005-306950 discloses a resin molding product such as a water pipe of forming a single layer product or the outermost layer of a multilayer product with a resin composition containing 100 parts by weight of a polyamide resin comprising 40 to 99% by weight of polyamide 66 and 1 to 60% by weight of an aromatic polyamide resin and 3 to 40 parts by weight of an impact resistant material. Since a water pipe molded into a single layer by the resin composition can be put to corrugation molding or complicate bending work, it has a great degree of freedom of design and also excellent in the calcium chloride resistance or impact resistance. However, it cannot be said that the hydrolysis resistance is sufficient.

Further, JP-A No. 2004-217698 discloses the following thermoplastic elastomer composition based on polyamide 9T (polyamide obtained by copolymerization reaction of nonanediamine (number of carbon atoms of 9) and terephthalic acid) excellent in heat resistance, low water absorption, etc. which is developed as a material for various kinds of molding products such as automobile parts. “A thermoplastic polymer composition mainly comprising a polyamide resin (I), an elastomer (II) and a cross linker; in which

the polyamide resin (I) is a polyamide resin comprising a dicarboxylic acid unit (Ia) containing from 60 to 100 mol % of a terephthalic acid unit and a diamine unit (Ib) containing from 60 to 100 mol % of a 1,9-nonanediamine unit and a 2-methyl-1,8-octanediamine unit in which the molar ratio of the 1,9-nonanediamine unit and the 2-methyl-1,8-octanediamine unit is from 100:0 to 20:80;

the mass ratio of the polyamide resin (I) and the elastomer (II) is 99:1 to 1:99; and

the elastomer (II) is dynamically crosslinked under a melting condition.

The present inventors have studied on the use of the thermopolymer composition of JP-A No. 2004-217698 for the water pipe. However, the water pipe molded with the thermoplastic polymer composition into a single layer satisfied the resistance of calcium chloride and the impact resistance, but the hydrolysis resistance, the flowability and the moldability could not be said to be sufficient.

### SUMMARY OF THE INVENTION

In view of the above, the subject of the present invention is to provide a water pipe for use in automobiles not only capable of satisfying all of the hydrolysis resistance, heat resistance and calcium chloride resistance as the characteristics required during use but also capable of ensuring the moldability as the characteristics required in molding. Further, it intends to provide a water pipe for use in automobiles capable of adopting a single layer structure and also ensuring the corrugation moldability, pressure proofness, bendability and shape retainability.

A water pipe for use in automobiles according to the invention is molded with a thermoplastic polymer composition mainly comprising a polyamide resin (I) and a polyolefin (II); in which

the polyamide resin (I) is a polyamide resin comprising a dicarboxylic acid unit (Ia) containing from 60 to 100 mol % of a terephthalic acid unit and a diamine unit (Ib) containing from 60 to 100 mol % of a 1,9-nonanediamine unit and a 2-methyl-1,8-octanediamine unit in which the molar ratio of the 1,9-nonanediamine unit and the 2-methyl-1,8-octanediamine unit is from 60:40 to 50:50;

the amount of the terminal amino groups of the polyamide resin (I) is 60 μmol/g or more and the amount of terminal carboxyl groups of the polyamide resin (I) is 10 μmol/g or less;

the polyolefin (II) contains an acid modified polyolefin and a not acid modified polyolefin at a mass ratio of 80:20 to 20:80 and, as a result, the amount of acid modification is from 0.2 to 0.5 mass %; and

the mass ratio of the polyamide resin (I) and the polyolefin (II) is 90:10 to 70:30.

The water pipe for use in automobiles obtained as described above has the following function.
(a) The heat resistance, the calcium chloride resistance and the impact resistance as the characteristic required in use are satisfied by the material characteristic of the thermoplastic polymer composition, in which a polyamide resin (I) is a polyamide resin comprising a dicarboxylic acid unit (Ia) containing from 60 to 100 mol % of a terephthalic acid unit and a diamine unit (Ib) containing from 60 to 100 mol % of a 1,9-nonanediamine unit and a 2-methyl-1,8-octanediamine unit in which the molar ratio of the 1,9-nonanediamine unit and the 2-methyl-1,8-octanediamine unit is from 60:40 to 50:50; and the mass ratio of the polyamide resin (I) and the polyolefin (II) is from 90:10 to 70:30.
(b) Further, the characteristics required in use can be satisfied since it is excellent in the hydrolysis resistance due to the material characteristic of the thermoplastic polymer composition in which the amount of the terminal amino groups of the polyamide resin (2) is 60 μmol/g or more and the amount of the terminal carboxyl groups of the polyamide resin (I) is 10 μmol/g or less.
(c) Further, the mechanical property is improved and the impact resistance can be satisfied since the polyolefin (II) contains an acid modified polyolefin and a not acid modified polyolefin at a mass ratio of 80:20 to 20:80 and, as a result, contains a polyolefin with the amount of acid modification of from 0.2 to 0.5 mass %. Further, the viscosity is lowered and the moldability as the characteristic required in molding can be ensured since it contains a not acid modified polyolefin and, as a result, the amount of acid modification is from 0.2 to 0.5 mass %. In a case where the polyolefin (II) consisted only of the acid-modified product, though the impact resistance can be satisfied, the flowability and the moldability are deteriorated because of high viscosity and the viscosity is not lowered so much even when the amount of the acid modification of the acid modified product is lowered (for example, from 0.2 to 0.5 mass % in the same manner). The difference of the function has been found for the first time (refer to Tables 1-1 through 3-2 and FIG. 2 to be described later).

According to the water pipe for automobiles of the present invention, not only all of the hydrolysis resistance, the heat resistance and the calcium chloride resistance which are the characteristic required in use can be satisfied but also the moldability as the characteristic required in molding can be ensured due to the material characteristic. Further, it is also possible to adopt the single layer structure and ensure the corrugation moldability, pressure resistance, bendability and shape retainability.

### BRIEF DESCRIPTION OF THE DRAWINGS

FIG. 1A is a perspective view showing a non-bellows shape molded in the examples, FIG. 1B is a perspective view also showing a bellows shape pipe and FIG. 1C is also a perspective view showing a pipe of a complicate shape.

FIG. 2 is a graph showing MFR value to the amount of acid modification in examples and comparative examples.

FIG. 3 is a schematic view showing the method of measuring the change of bend angle (buckling) in examples and comparative examples.

FIG. 4 is a graph showing the change of bend angle for the non-bellows shape portion in examples and comparative examples.

FIG. 5 is a graph showing the change of bend angle for the bellows shape portion in examples and comparative examples.

In the drawings, “1” is a water pipe for automobiles, “2” is a straight shape portion, “3” is a bellows-shape portion and “4” is a bend point.

### DETAILED DESCRIPTION OF THE PREFERRED EMBODIMENTS

A water pipe for use in automobiles according to the present invention is molded with a thermoplastic polymer composition mainly comprising a polyamide resin (I) and a polyolefin (II); in which

the polyamide resin (I) is a polyamide resin comprising a dicarboxylic acid unit (Ia) containing from 60 to 100 mol % of a terephthalic acid unit and a diamine unit (Ib) containing from 60 to 100 mol % of a 1,9-nonanediamine unit and a 2-methyl-1,8-octanediamine unit in which the molar ratio of the 1,9-nonanediamine unit and the 2-methyl-1,8-octanediamine unit is from 60:40 to 50:50;

the amount of the terminal amino groups of the polyamide resin (I) is 60 μmol/g or more and the amount of the terminal carboxyl groups of the polyamide resin (I) is 10 μmol/g or less;

the polyolefin (II) contains an acid modified polyolefin and a not acid modified polyolefin at a mass ratio of from 80:20 to 20:80 and, as a result, the amount of acid modification is from 0.2 to 0.5 mass %; and

the mass ratio of the polyamide resin (I) and the polyolefin (II) is 90:10 to 70:30.

The ratio of the polyamide resin (I) and the polyolefin (II) in the thermoplastic polymer composition is, preferably, 60 mass % or more and, more preferably, 80 mass % or more.

1. Polyamide Resin (I)

The polyamide resin (I) provides a thermoplastic polymer composition with excellent hydrolysis resistance, heat resistance and calcium chloride resistance, as well as with low water absorption, oil resistance, chemical resistance, buckling resistance, etc.

1-1. Dicarboxylic Acid Unit (Ia)

The dicarboxylic acid unit (Ia) constituting the polyamide resin (I) contains from 60 to 100 mol % of a terephthalic acid unit. In a case where the terephthalic acid unit is less than 60 mol %, it is not preferred since the heat resistance of the thermoplastic polymer composition is lowered.

Other dicarboxylic acid units other than the terephthalic acid unit that can be contained in the polyamide resin (I) include units derived from aliphatic dicarboxylic acids such as malonic acid, dimethyl malonic acid, succinic acid, glutaric acid, adipic acid, 2-methyladipic acid, trimethyladipic acid, pimelic acid, 2,2-dimethyl glutaric acid, 2,2-diethyl succinic acid, azelaic acid, sebacic acid and suberic acid; alicyclic dicarboxylic acids such as 1,3-cyclopentanedicarboxylic acid and 1,4-cyclohexanedicarboxylic acid; aromatic dicarboxylic acid such as isophthalic acid, 2,6-naphthalenedicarboxylic acid, 2,7-naphthalenedicarboxylic acid, 1,4-naphthalenedicarboxylic acid, 1,4-phenylenedioxydiacetic acid, 1,3-phenylenedioxydiacetic acid, diphenic acid, dibenzoic acid, 4,4′-oxydibenzoic acid, diphenylmethane-4,4′-dicarboxylic acid, diphenylsulfone-4,4′-dicarboxylic acid and 4,4′-biphenyldicarboxylic acid; or optional mixtures thereof. Among them, units derived from the aromatic dicarboxylic acids are used preferably. Further, units derived from multi-valent carboxylic acids such as trimellitic acid, trimesic acid, and pyromellitic acid can be used within a range that assures melt molding.

1-2. Diamine Unit (Ib)

Further, the diamine unit (Ib) constituting the polyamide resin (I) contains a 1,9-nonanediamine unit and a 2-methyl-1,8-octanediamine unit by from 60 to 100 mol %. In a case where the 1,9-nonanediamine unit and the 2-methyl-1,8-octanediamine unit are less than 60 mol %, it is not preferred since the characteristic such as the heat resistance, the moldability and the low water absorption of the thermoplastic polymer composition are insufficient.

Further, the molar ratio of the 1,9-nonanediamine unit and the 2-methyl-1,8-octanediamine unit is from 60:40 to 50:50. In a case where the content of the 1,9-nonanediamine unit is more than the ratio described above, since the melting point becomes higher, it is necessary to set the molding temperature higher in a case of manufacturing molding products by extrusion molding or the like. Further, since the crystallization rate increases, the extrusion molding is sometime difficult. Further, the tensile elongation, the impact resistance, etc. of the polyamide resin are sometimes deteriorated in view of the mechanical property. On the other hand, in a case where the content of the 1,9-nonanediamine unit is less than the ratio described above, it is not preferred since the crystallinity is lowered and the heat resistance is lowered.

Other diamine units other than the 1,9-nonanediamine unit and the 2-methyl-1,8-octanediamine unit include units derived from aliphatic diamines such as ethylenediamine, propylenediamine, 1,4-butanediamine, 1,6-hexanediamine, 1,8-octanediamine, 1,10-decanediamine, 1,12-dodecanediamine, 3-methyl-1,5-pentanediamine, 2,2,4-trimethyl-1,6-hexanediamine, 2,4,4-trimethyl-1,6-hexanediamine and 5-methyl-1,9-nonanediamine; alicyclic diamines such as cyclohexanediamine, methylcyclohexanediamine and isophoronediamine; aromatic diamines such as p-phenylenediamine, m-phenylenediamine, xylenediamine, 4,4′-diaminodiphenylmethane, 4,4′-diaminodiphenylsulfone and 4,4′-diamino diphenyl ether; or optional mixtures thereof.

1-3. Terminal Group

In the polyamide resin (I), the amount of the terminal amino groups is 60 μmol/g or more and the amount of the terminal carboxylic groups is 10 μmol/g or less. In a case where the amount of the terminal amino groups in the polyamide resin (I) is less than 60 μmol/g, it is not preferred since the hydrolysis resistance becomes insufficient. Further, in a case where the amount of the terminal carboxylic group exceeds 10 μmol/g, the hydrolysis resistance tends to be insufficient.

1-4. Production Process

The polyamide resin (I) used in the present invention can be produced by any method known as a method of producing crystalline polyamides. It can be polymerized by a method, for example, a solution polymerization method or an interfacial polymerization method of using an acid chloride and a diamine as the starting material, a melt polymerization method, a solid phase polymerization method or a polymerization method in a melt extruder by using a dicarboxylic acid and a diamine as the starting material. An example of the polymerization method for the polyamide resin (I) is shown below.

According to the study of the present inventors, the polyamide resin (I) can be obtained easily by at first adding a catalyst together with, as necessary, a terminal blocking agent to a diamine and a dicarboxylic acid collectively, to produce a nylon salt, then once forming a prepolymer with an intrinsic viscosity [η] at 30° C. of from 0.10 to 0.60 dl/g in a concentrated sulfuric acid at a temperature of from 200 to 250° C., and then further conducting solid phase polymerization or melt-polymerization by using an extruder. In a case where the intrinsic viscosity [η] of the prepolymer is within a range from 0.10 to 0.60 dl/g, a polyamide resin (I) with less deviation of the mole balance between the carboxylic acid and the amino acid and less lowering of the polymerization rate in the last stage of the polymerization, further with narrow molecular weight distribution and excellent in various kinds of performances and moldability can be obtained. In a case of conducting the final stage of the polymerization by the solid phase polymerization, it is preferably conducted under a reduced pressure or under passage of an inert gas, and a temperature of polymerization within a range from 200 to 280° C. is preferred since the polymerization rate is high, the productivity is excellent and coloration or gelation can be suppressed effectively. In a case of conducting the final stage of polymerization by an extruder, the polymerization temperature is preferably 370° C. or lower since a polyamide scarcely decomposes and a polyamide resin (I) with no degradation can be obtained.

Further, the amount of the terminal amino groups and the amount of the terminal carboxyl groups in the polyamide resin (I) used in the present invention can be adjusted by controlling the amount of charging the starting material such as the diamine or the dicarboxylic acid used in the polymerization or the degree of following polymerization reaction. For example, a polyamide resin (I) with the amount of the terminal amino groups of 60 μmol/g or more and the amount of the terminal carboxylic groups of 10 μmol/g or less can be obtained by using a starting material so as to satisfy the following relation assuming the molar number for all of the carboxyl groups as (X) and the molar number for all of the amino groups therein as (Y) contained in the starting material to be used as: 1.0≦[(Y−X)/Y]×100≦6.0

In the production of the polyamide resin (I), it is possible to add a catalyst, for example, phosphoric acid, phosphorus acid, hypophosphorus acid, or salts or esters thereof, specifically, metal salts such as potassium salt, sodium salt, magnesium salt, vanadium salt, calcium salt, zinc salt, cobalt salt, manganese salt, tin salt, tungsten salt, germanium salt, titanium salt, and antimony salt, ammonium salts, ethyl ester, isopropyl ester, butyl ester, hexyl ester, isodecyl ester, octadecyl ester, decyl ester, stearyl ester or phenyl ester.

1-5. Viscosity

The polyamide resin (I) used in the present invention has an intrinsic viscosity [η] measured under the condition at 30° C. in a concentrated sulfuric acid of, preferably, from 0.6 to 2.0 dl/g, more preferably, from 0.7 to 1.9 dl/g and, further preferably, from 0.8 to 1.8 dl/g in view of the mechanical property and the moldability.

2. Polyolefin (II)

The polyolefin (II) used in the present invention provides the thermoplastic polymer composition with flexibility and impact resistance.

2-1. Polyolefin

The polyolefin (II) in the present invention includes, for example, butyl rubber; ethylenic elastomers such as ethylene-propylene copolymer (EPR), ethylene-propylene-non conjugated diene copolymer (EPDM), ethylene-butene copolymer (EBR) and ethylene-octene copolymer (EOR); styrene-butadiene copolymer (SBR) and polybutadiene. Among them, those used particularly preferably in the present invention are EPR and EBR. The polyolefins (II) may be used each alone or two or more of them can be used in combination.

The molecular weight of the polyolefin (II) is not particularly restricted and the number average molecular weight of the entire polyolefin (II) is suitably within a range from 12,500 to 2,000,000 and, preferably, from 50,000 to 1,000,000 in view of the mechanical property and the moldability of the obtained thermoplastic polymer composition. The number average molecular weight (Mn) means a value determined from a standard polystyrene calibration curve according to gel permeation chromatography (GPC).

2-2. Acid Modification

The polyolefin (II) contains an acid modified polyolefin and a not acid modified polyolefin at a mass ratio of from 80:20 to 20:80 and, as a result, the amount of acid modification therein is from 0.2 to 0.5 mass %. As described above, the mechanical property is improved and the required impact resistance is satisfied by incorporation of the acid modified polyolefin. Further, since it contains the not acid modified polyolefin and, as a result, the amount of acid modification is from 0.2 to 0.5 mass %, the viscosity is lowered and the moldability as the characteristic required during molding can be ensured. In a case where the polyolefin (II) consisted only of the acid modification product, or in a case where the not acid modified product is mixed but only at the molar ratio thereof of less than 20 mass %, although the required impact resistance is satisfied, the moldability is lowered because of high viscosity and, for example, the viscosity is not lowered by so much although the amount of the acid modification for the entire polyolefin (II) is low.

The acid used for the acid modification treatment is not particularly restricted and includes, for example, dicarboxylic acids such as maleic acid or itaconic acid, or anhydrides thereof.

In the present specification, the amount of the acid modification of the polyolefin means the mass of the acid used for the acid modification treatment based on the entire mass of the polyolefin after the acid modification.

In view of 2-1 and 2-2 described above, the polyolefin (II) is preferably a mixture of one or both of the acid modified EPR and the acid modified EBR and one or both of not acid modified EPR and not acid modified EBR.

2-3. Blending Ratio

The blending amount of the polyolefin (II) in the thermoplastic polymer composition is such that the mass ratio of the polyamide resin (I) and the polyolefin (II) is from 90:10 to 70:30. A ratio out of the range described above is not preferred since the performance of the polyamide resin (I) or the polyolefin (II) is less developed. Specifically, in a case where the polyolefin (II) is less than the range, the moldability and the impact resistance cannot be satisfied sufficiently. In a case where it exceeds the range described above, it is not preferred since the mechanical strength, particularly, the strength at high temperature is worsened.

2-4. Production Process

The polyolefin (II) described above can be produced by known polymerization methods, for example, an ionic polymerization method such as anion polymerization or cation polymerization, or radical polymerization method.

3. Other Composition for Blend

3-1. Softening Agent for Rubber

A softening agent used for rubber of known mineral oil type or synthetic resin type may further be blended optionally to the thermoplastic polymer composition for improving the flexibility of the thermoplastic polymer composition. The blending amount of the softening agent for rubber is preferably 200 mass parts or less based on 100 mass parts of the polyolefin (II). As the softening agent for rubber, paraffinic oils are used preferably. The kinematic viscosity of the paraffinic oil at 40° C. is preferably from 20×10⁻⁶ to 800×10⁻⁶ m²/sec and, more preferably, from 50×10⁻⁶ to 600×10⁻⁶ m²/sec. Further, a pour point is, preferably, from −40 to 0° C. and, more preferably, from −30 to 0° C. Further, a flash point is preferably from 200 to 400° C. and, more preferably, from 250 to 350° C. The paraffinic oil may be immersed in the polyolefin (II), followed by melt-kneading, may be added in the course of the melt kneading, or both of immersion before and addition in the course of melt-kneading may be conducted in the production of the thermoplastic polymer composition.

3-2. Other Thermoplastic Resin

The thermoplastic polymer composition may further contain other thermoplastic resins. The thermoplastic resin include, for example, ethylenic copolymer resins such as ethylene-vinyl acetate copolymer, ethylene-(meth)acrylic acid copolymer and ethylene-(meth)acrylic acid ester copolymer; polyester resins such as polyethylene terephthalate and polybutylene terephthalate; acrylic resins such as polymethyl acrylate and polymethyl methacrylate and polyoxymethylene resins such as polyoxymethylene homopolymer and polyoxymethylene copolymer. The content of the thermoplastic resin is preferably within such a range as not deteriorating the oil resistance and the dynamic property of the obtained thermoplastic polymer composition and it is preferably about from 0 to 200 mass parts based on 100 mass parts of the polyolefin (II).

3-3. Inorganic Filler

The thermoplastic polymer composition may contain an inorganic filler. As the inorganic filler, for example, calcium carbonate, talc, wollastonite, clay, synthesis silicon, titanium oxide, carbon black, barium sulfate can be used. The content of the inorganic filler is preferably within such a range as not deteriorating the performance of the obtained thermoplastic polymer composition and it is preferably about from 0 to 50 mass parts based on 100 mass parts of the polyolefin (II).

3-4. Lubricant, Etc.

For the thermoplastic polymer composition, lubricant, releasing agent, light stabilizer, colorant (pigment), flame retardant, flame retardant synergist, heat resistant agent, weatherproof agent, antistatic agent, silicon oil, blocking inhibitor, UV-ray absorbent, antioxidant, etc. may also be added properly in addition to the ingredients described above within a range not deteriorating the purpose thereof.

4. Preparation Method

The thermoplastic polymer composition can be prepared, for example, as described below. That is, a polyamide resin (I), polyolefin (II) and, optionally, various kinds of additives such as a softening agent for rubber are at first mixed and charged in the hopper of an extruder. Further, two or more extruders may be used to conduct melt kneading successively stepwise.

The temperature for melt kneading is properly selected within a range that the polyamide resin (I) and the polyolefin (II) are melted and usually it is, preferably, from 270 to 330° C. and, more preferably, from 290 to 320° C. The melt kneading time is preferably about from 30 sec to 5 min.

5. Water Pipe

For the water pipe for use in automobiles according to the present invention, the thermoplastic polymer composition described above is used and can be molded and fabricated, for example, by a molding method such as an extrusion molding method, an injection molding method or a blow molding method.

5-1. Layer Structure

The water pipe for use in automobiles is preferably molded with the thermoplastic polymer composition into a mono-layer structure, which is particularly preferred in a case where bending points in the longitudinal direction by bending work after molding are included. This is because the change of angle for the bending point with lapse of time after bending work (buckling) is small in a case of a mono-layer structure. The bending radius at the center line in the bending work is preferably 1.5 times or more the outer diameter of the water pipe. In a case where it is less than 1.5 times, the inside of the pipe bent portion is compressed greatly whereby the material protrudes to the inner surface to be blockage and it sometimes fails to ensure a necessary flow rate. Further, the bending angle is preferably from 5 to 180°. In a case where it is less than 5°, it is a range capable of coping with a straight shape. In a case where it exceeds 180°, a portion of the inside of the pipe bent portion is compressed greatly and closed by the protrusion of the material to the inner surface, sometimes failing to ensure a necessary flow rate.

5-2. Pipe Shape

The pipe shape is not particularly restricted and for example, it may be a straight shape with no corrugation (non-bellows shape) or a bellows shape (corrugated pipe).

### EXAMPLES

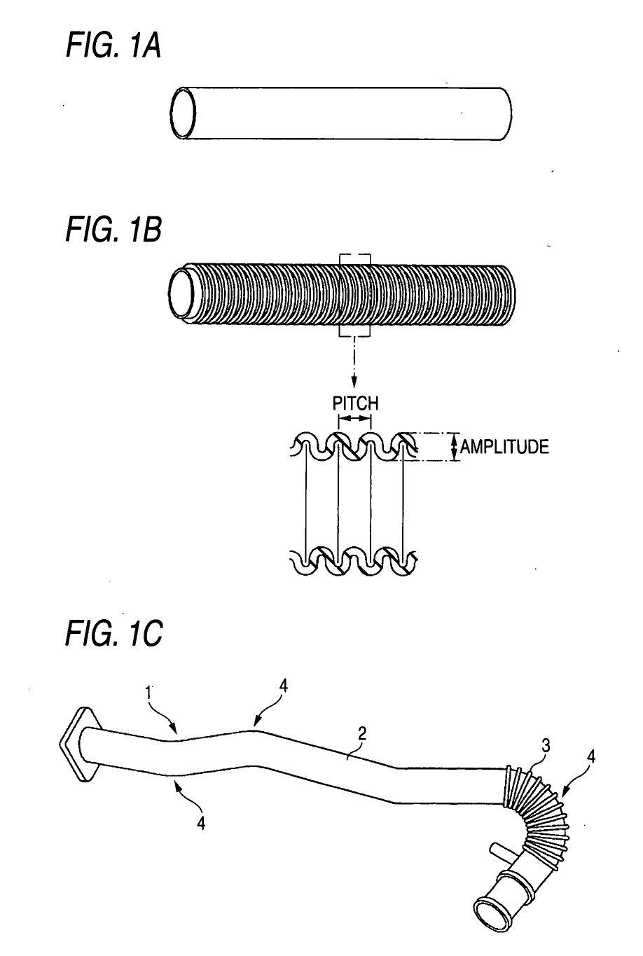

Then, thermoplastic polymer compositions of Examples 1 to 5 and Comparative Examples 1 to 13 shown in the following Tables 1-1 and 1-2 were prepared, test pieces were molded and various properties were examined, as well as non-bellows shape pipes shown in FIG. 1A and bellows shape pipes shown in FIG. 1B were molded and the moldability and the shape retainability were examined.

Examples 1 to 5 are compositions in which the polyamide 9T (PA9T) and the polyolefin specified in the present invention were blended.

Comparative Example 1 is polyamide 6 (PA6), Comparative Example 2 is polyamide 66 (PA66), Comparative Example 3 is polyphenylene sulfide (PPS), and Comparative Example 4 is polyamide 9T (PA9T).

Other comparative examples 5 to 13 are compositions in which the polyamide 9T (PA9T) and the polyolefin were blended, but one or both of PA9T and polyolefin are different from that specified in the present invention.

TABLE 1

| | | Comp. | Comp. | Comp. | Comp. | Comp. | Comp. | Comp. | Comp. | Comp. | Comp. |
|---|---|---|---|---|---|---|---|---|---|---|---|
| | | Exam. 4 | Exam. 5 | Exam. 6 | Exam. 7 | Exam. 8 | Exam. 9 | Exam. 10 | Exam. 11 | Exam. 12 | Exam. 13 |
| | | PA9T | | | | | | | | | |
| PA9T | N/I: molar ratio of 1,9- | 60/40 | 60/40 | 60/40 | 60/40 | 50/50 | 50/50 | 50/50 | 50/50 | 50/50 | 50/50 |
| | nonanediamine unit and 2- | | | | | | | | | | |
| | methyl-1,8-octanediamine | | | | | | | | | | |
| | unit | | | | | | | | | | |
| | Amount of terminal amino | 8 | 8 | 80 | 80 | 8 | 80 | 80 | 80 | 80 | 80 |
| | groups (μ mol/g) | | | | | | | | | | |
| | Amount of terminal | 50 | 50 | 5 | 5 | 50 | 5 | 5 | 5 | 5 | 5 |
| | carboxyl groups (μ mol/g) | | | | | | | | | | |
| Polyolefin | Type | — | EPR | EPR | EBR | EPR | EPR | EBR | EPR | EPR | EPR |
| | Amount of acid | — | 0.8 | 0.8 | 1.0 | 0.8 | 0.8 | 1.0 | 0.5 | 0.3 | 0.6 |
| | modification (wt %) | | | | | | | | | | |
| Compositional | PA9T | 100 | 80 | 80 | 80 | 80 | 80 | 80 | 80 | 80 | 80 |
| ratio | Polyolefin (amount of acid | 0 | 0 | 0 | 20 | 0 | 0 | 20 | 0 | 0 | 0 |
| (mass ratio) | modification: 1.0 wt %) | | | | | | | | | | |
| | Polyolefin (amount of acid | | 20 | 20 | 0 | 20 | 20 | 0 | 0 | 0 | 15 |
| | modification: 0.8 wt %) | | | | | | | | | | |
| | Polyolefin (amount of acid | | 0 | 0 | 0 | 0 | 0 | 0 | 20 | 0 | 0 |
| | modification: 0.5 wt %) | | | | | | | | | | |
| | Polyolefin (amount of acid | | 0 | 0 | 0 | 0 | 0 | 0 | 0 | 20 | 0 |
| | modification: 0.3 wt %) | | | | | | | | | | |
| | Not-modified polyolefin | | 0 | 0 | 0 | 0 | 0 | 0 | 0 | 0 | 5 |

| | | Exam. 1 | Exam. 2 | Exam. 3 | Exam. 4 | Exam. 5 |
|---|---|---|---|---|---|---|
| | | PA9T | | | | |
| PA9T | N/I: molar ratio of 1,9- | 60/40 | 50/50 | 50/50 | 50/50 | 50/50 |
| | nonanediamine unit and 2- | | | | | |
| | methyl-1,8-octanediamine | | | | | |
| | unit | | | | | |
| | Amount of terminal amino | 80 | 80 | 80 | 80 | 80 |
| | group (μ mol/g) | | | | | |
| | Amount of terminal | 5 | 5 | 5 | 5 | 5 |
| | carboxyl groups (μ mol/g) | | | | | |
| Polyolefin | Type | EPR | EPR | EPR | EPR | EPR |
| | Amount of acid | 0.4 | 0.5 | 0.4 | 0.3 | 0.2 |
| | modification (wt %) | | | | | |
| Compositional | PA9T | 80 | 80 | 80 | 80 | 80 |
| ratio | Polyolefin (amount of acid | 0 | 0 | 0 | 0 | 0 |
| (mass ratio) | modification: 1.0 wt %) | | | | | |
| | Polyolefin (amount of acid | 10 | 12.5 | 10 | 7.5 | 5 |
| | modification: 0.8 wt %) | | | | | |
| | Polyolefin (amount of acid | 0 | 0 | 0 | 0 | 0 |
| | modification: 0.5 wt %) | | | | | |
| | Polyolefin (amount of acid | 0 | 0 | 0 | 0 | 0 |
| | modification: 0.3 wt %) | | | | | |
| | Not-modified polyolefin | 10 | 7.5 | 10 | 12.5 | 15 |

TABLE 2

| | | | Comp. | Comp. | Comp. | Comp. | Comp. | Comp. | Comp. | Comp. | Comp. |
|---|---|---|---|---|---|---|---|---|---|---|---|
| | | | Exam. 1 | Exam. 2 | Exam. 3 | Exam. 4 | Exam. 5 | Exam. 6 | Exam. 7 | Exam. 8 | Exam. 9 |
| | | | PAS | PASS | PPS | PAST | | | | | |
| Specific gravity | | — | 1.09 | 1.14 | 1.21 | 1.14 | 1.05 | 1.06 | 1.06 | 1.06 | 1.06 |
| Melting point | | ° C. | 225 | 260 | 278 | 276 | 276 | 276 | 276 | 267 | 267 |
| Water absorption (in water | | % | 1.8 | 1.3 | 0.02 | 0.4 | 0.35 | 0.36 | 0.33 | 0.32 | 0.34 |
| at 23° C., 24 H) | | | | | | | | | | | |
| Linear expansion coefficient | | | | | | | | | | | |
| MD direction | | ×10⁻⁵ cm/cm/° C. | 10 | 13 | 8.6 | 6.5 | 8.7 | 9.4 | 9.2 | 9.4 | 9.3 |
| (−30° C.˜120° C.) | | | | | | | | | | | |
| TD direction | | ×10⁻⁵ cm/cm/° C. | 10 | 13 | 9.6 | 6 | 8.5 | 8.8 | 8.4 | 8.7 | 8.5 |
| Glass transition temperature | | ° C. | 50 | 45 | 90 | 125 | 119 | — | — | — | — |
| Tensile strength | | MPa | 58 | 80 | 44 | 87 | 49 | 52 | 48 | 49 | 51 |
| Tensile elongation | (23° C.) | % | 161 | 140 | 20 | 22 | 68 | 53 | 42 | 66 | 49 |
| | (120° C.) | % | >200 | >200 | >80 | 86 | 115 | 103 | 96 | 108 | 128 |
| Bending strength | (23° C.) | MPa | 80 | 112 | 59 | 113 | 57 | 55 | 57 | 57 | 56 |
| | (120° C.) | MPa | 14 | 23 | 11 | 25 | 15 | 15 | 14 | 12 | 12 |
| Bending modulus of | (23° C.) | GPa | 2.1 | 2.9 | 1.7 | 2.4 | 1.37 | 1.31 | 1.33 | 1.33 | 1.30 |
| elasticity | (120° C.) | GPa | 0.25 | 0.4 | 0.19 | 1.2 | 0.36 | 0.33 | 0.32 | 0.28 | 0.28 |

| | | | Comp. | Comp. | Comp. | Comp. | | | | | |
|---|---|---|---|---|---|---|---|---|---|---|---|
| | | | Exam. 10 | Exam. 11 | Exam. 12 | Exam. 13 | Exam. 1 | Exam. 2 | Exam. 3 | Exam. 4 | Exam. 5 |
| | | | PA9T | | | | | | | | |
| Specific gravity | | — | 1.06 | 1.06 | 1.06 | 1.06 | 1.06 | 1.06 | 1.06 | 1.06 | 1.06 |
| Melting point | | ° C. | 267 | 267 | 267 | 267 | 276 | 267 | 267 | 267 | 267 |
| Water absorption (in water | | % | 0.36 | — | — | — | 0.33 | — | 0.35 | — | — |
| at 23° C., 24 H) | | | | | | | | | | | |
| Linear expansion coefficient | | | | | | | | | | | |
| MD direction | | ×10⁻⁵ cm/cm/° C. | 9.4 | — | — | — | 9.2 | — | 9.4 | — | — |
| (−30° C.˜120° C.) | | | | | | | | | | | |
| TD direction | | ×10⁻⁵ cm/cm/° C. | 8.4 | — | — | — | 8.7 | — | 7.8 | — | — |
| Glass transition temperature | | ° C. | — | — | — | — | 119 | 119 | 119 | 119 | 119 |
| Tensile strength | | Mpa | 49 | 48 | 49 | 48 | 48 | 48 | 49 | 54 | 48 |
| Tensile elongation | (23° C.) | % | 43 | 36 | 44 | 42 | 71 | 42 | 63 | 79 | 56 |
| | (120° C.) | % | 118 | — | — | — | >150 | — | 144 | — | — |
| Bending strength | (23° C.) | MPa | 57 | 57 | 58 | 58 | 57 | 58 | 59 | 59 | 60 |
| | (120° C.) | MPa | 12 | — | — | 13 | 14 | — | 12 | — | — |
| Bending modulus of | (23° C.) | GPa | 1.34 | 1.28 | 1.33 | 1.35 | 1.32 | 1.35 | 1.36 | 1.36 | 1.38 |
| elasticity | (120° C.) | GPa | 0.24 | — | — | 0.29 | 0.33 | — | 0.27 | — | — |

TABLE 3

| | | | Comp. | Comp. | Comp. | Comp. | Comp. | Comp. | Comp. | Comp. | Comp. |
|---|---|---|---|---|---|---|---|---|---|---|---|
| | | | Exam. 1 | Exam. 2 | Exam. 3 | Exam. 4 | Exam. 5 | Exam. 6 | Exam. 7 | Exam. 8 | Exam. 9 |
| | | | PAS | PASS | PPS | PA9T | | | | | |
| Notched Izod impact value @ | | J/m | 210 | 49 | 400 | 59 | NB | NB | NB | NB | NB |
| 23° C. | | | | | | | | | | | |
| Notched Izod impact value @ | | J/m | 146 | 30 | 100 | 34 | NB | — | — | — | — |
| −30° C. | | | | | | | | | | | |
| Notched Izod impact value @ | | J/m | — | — | — | 25 | NB | NB | NB | NB | NB |
| −40° C. | | | | | | | | | | | |
| DTUL | (1.82 MPa) | ° C. | 57 | 90 | 100 | 120 | 119 | 120 | 122 | 118 | 119 |
| | (0.45 MPa) | ° C. | 160 | 230 | 175 | 198 | 193 | 194 | 190 | 177 | 171 |

| | | | | | | | | | | |
|---|---|---|---|---|---|---|---|---|---|---|
| Hydrolysis resistance | % | 37 | — | — | 40 | 53 | 79 | 77 | 47 | 75 |
| Molecular weight | | | | | | | | | | |
| retension | | | | | | | | | | |
| Tensile strength | % | Cracked | — | — | Cracked | 56 | 83 | 81 | 37 | 83 |
| retention | | Measurement | | | Measurement | | | | | |
| | | impossible | | | impossible | | | | | |
| Calcium chloride resistance | Cycle | 27 | 45 | >100 | >100 | >100 | — | — | — | — |
| MFR (320° C., 5 kg) | g/10 min | — | — | 65 | 12 | 0.8 | 0.3 | 0.3 | 1.1 | 0.3 |
| Product moldability | Corrugate | ◯ | ◯ | ◯ | ◯ | ◯ | X | — | — | X |
| | molding | | | | | | | | | |
| Product shape retainability | | | | Bending | Bending | | | | | |
| Bending angle change | % | 37.8 | 15.6 | fabrication | fabrication | — | — | — | — | — |
| coefficient for non-bellows | | | | impossible | impossible | | | | | |
| shape portion | | | | | | | | | | |
| Bending angle change | % | 28.5 | 13.5 | | | — | — | — | — | — |
| coefficient for bellows | | | | | | | | | | |
| shape portion | | | | | | | | | | |

| | | | Comp. | Comp. | Comp. | Comp. | | | | | |
|---|---|---|---|---|---|---|---|---|---|---|---|
| | | | Exam. 10 | Exam. 11 | Exam. 12 | Exam. 13 | Exam. 1 | Exam. 2 | Exam. 3 | Exam. 4 | Exam. 5 |
| | | | PA9T | | | | | | | | |
| Notched Izod impact value @ | | J/m | NB | NB | NB | NB | NB | NB | NB | NB | NB |
| 23° C. | | | | | | | | | | | |
| Notched Izod impact value @ | | J/m | — | — | — | — | NB | — | NB | — | — |
| −30° C. | | | | | | | | | | | |
| Notched Izod impact value @ | | J/m | NB | NB | NB | NB | NB | NB | NB | 865 | 451 |
| −40° C. | | | | | | | | | | | |
| DTUL | (1.82 MPa) | ° C. | 110 | 119 | 119 | 117 | 119 | 118 | 118 | 118 | — |
| | (0.45 MPa) | ° C. | 177 | 173 | 173 | 174 | 194 | 175 | 174 | 171 | 175 |

| | | | | | | | | | | |
|---|---|---|---|---|---|---|---|---|---|---|
| Hydrolysis resistance | % | 72 | — | — | — | 96 | — | 86 | — | — |
| Molecular weight | | | | | | | | | | |
| retention | | | | | | | | | | |
| Tensile strength | % | 78 | — | — | — | 81 | — | 82 | — | — |
| retention | | | | | | | | | | |
| Calcium chloride resistance | Cycle | — | — | — | — | >100 | — | >100 | — | — |
| MFR (320° C., 5 kg) | g/10 min | 0.4 | 0.3 | 0.2 | 0.3 | 1.1 | 0.51 | 0.89 | 1.7 | 3.4 |
| Product moldability | Corrugate | — | — | — | — | ◯ | ◯ | ◯ | ◯ | ◯ |
| | molding | | | | | | | | | |
| Product shape retainability | | | | | | | | | | |
| Bending angle change | % | — | — | — | — | 3.9 | — | — | — | — |
| coefficient for non-bellows | | | | | | | | | | |
| shape portion | | | | | | | | | | |
| Bending angle change | % | — | — | — | — | 2.9 | — | — | — | — |
| coefficient for bellows | | | | | | | | | | |
| shape portion | | | | | | | | | | |

Details for each component of blends in Tables 1-1 through 3-2 are to be described.

PA6: “Amilan CM1056” trade name of products by Toray Industries Inc. was used.

PA66: “Ube Nylon 2026B” trade name of products by Ube Industries Ltd. was used.

PPS: “TORELINA A670X01 670X01” trade name of products by Toray Industries Inc. was used.

PA9T: those manufactured by the following production Examples 1 to 4 were used.

### Production Example 1

### Production of PA9T (Amount of Terminal Amino Groups: 8 μmol/g, Molar Ratio (N/I) of 1,9-nonanediamine Unit and 2-methyl-1,8-octanediamine Unit: 60/40)

10178 g (61.3 mol) of terephthalic acid, 9746 g (61.6 mol) of a mixture of 1,9-nonanediamine and 2-methyl-1,8-octanediamine [1,9-nonanediamine/2-methyl-1,8-octanediamine=60/40 (molar ratio)], 75.2 g (0.62 mol) of benzoic acid, 20 g of sodium hypophosphite monohydrate (0.1 mass % based on the total mass of the starting material), and 5 L of distilled water were charged in an autoclave of 40 L inner volume, and subjected to nitrogen substitution. The mixture was stirred at 100° C. for 30 min, and the temperature inside the autoclave was elevated to 220° C. for 2 hours. In this case, the pressure inside the autoclave was increased up to 2 MPa. After continuing the reaction as it was for 2 hours, the temperature was elevated to 230° C. and then kept at 230° C. for 2 hours, steams were withdrawn gradually and they were reacted while keeping the pressure at 2 MPa. Then, the pressure was lowered to 1 MPa for 30 min and they were reacted for further 1 hour to obtain a prepolymer with an intrinsic viscosity [η] of 0.15 dl/g.

The obtained prepolymer was dried at 100° C. under a reduced pressure for 12 hours and pulverized to a grain size of 2 mm or less. They were put to solid phase polymerization at 230° C. and 13 Pa (0.1 mmHg) for 10 hours to obtain a polyamide resin (PA9T) with the melting point of 276° C., the intrinsic viscosity [η] of 1.4 dl/g, the amount of terminal amino groups of 8 μmol/g, the amount of terminal carboxyl groups of 50 μmol/g and the percentage of terminal blocking of 90%.

The amount of the terminal amino groups in PA9T was measured by using a sample solution prepared by dissolving 1 g of PA9T to 35 mL of phenol under heating and adding 3 mL of methanol and conducting titration by an aqueous 0.1N solution of HCl using thymol blue as an indicator. Further, the amount of the terminal carboxylic groups in PA9T was measured by using a sample solution prepared by dissolving 1 g of PA9T in 60 mL of m-cresol under heating, then cooling the same and conducting potential difference titration by using a 0.1N methanol solution of KOH.

### Production Example 2

### Production of PA9T (Amount of Terminal Amino Groups: 80 μmol/g, molar ratio (N/I) of 1,9-nonanediamine Unit and 2-methyl-1,8-octanediamine Unit: 60/40)

By the same procedures as those in Production Example 1 except for changing the amount of use of mixture of 1,9-nonanediamine and 2-methyl-1,8-octanediamine from 9746 g (61.6 mol) to 9990 g (63.1 mol), a polyamide resin (PA9T) with the melting point of 276° C., the intrinsic viscosity [η] of 1.4 dl/g, the amount of terminal amino groups of 80 μmol/g, the amount of terminal carboxylic groups of 5 μmol/g and the percentage of terminal blocking of 90% was obtained.

### Production Example 3

### Production of PA9T (Amount of Terminal Amino Groups: 8 μmol/g, Molar Ratio (N/I) of 1,9-nonanediamine Unit and 2-methyl-1,8-octanediamine Unit: 50/50)

By the same procedures as those in Production Example 1 except for replacing 9746 g (61.6 mol) of a mixture of 1,9-nonanediamine and 2-methyl-1,8-octanediamine [1,9-nonanediamine/2-methyl-1,8-octanediamine=60/40 (molar ratio)] with 9746 g (61.6 mol) of a mixture of 1,9-nonanediamine and 2-methyl-1,8-octanediamine [1,9-nonanediamine/2-methyl-1,8-octanediamine=50/50 (molar ratio)], a polyamide resin (PA9T) with the melting point of 267° C., the intrinsic viscosity [η] of 1.4 dl/g, the amount of terminal amino groups of 8 μmol/g, the amount of terminal carboxylic groups of 50 μmol/g and the percentage of terminal blocking of 90%.

### Production Example 4

### Production of PA9T (Amount of Terminal Amino Groups: 80 μmol/g, Molar Ratio (N/I) of 1,9-nonanediamine Unit and 2-methyl-1,8-octanediamine Unit: 50/50)

By the same procedures as those in Production Example 1 except for replacing 9746 g (61.6 mol) of a mixture of 1,9-nonanediamine and 2-methyl-1,8-octanediamine [1,9-nonanediamine/2-methyl-1,8-octanediamine=60/40 (molar ratio)] with 9990 g (63.1 mol) of a mixture of 1,9-nonanediamine and 2-methyl-1,8-octanediamine [1,9-nonanediamine/2-methyl-1,8-octanediamine=50/50 (molar ratio)], a polyamide resin (PA9T) with the melting point of 267° C., the intrinsic viscosity [η] of 1.4 dl/g, the amount of terminal amino groups of 80 μmol/g, the amount of terminal carboxylic groups of 5 μmol/g and the percentage of terminal blocking of 90% was obtained.

As the polyolefin, “T7761P” (acid modification amount: 0.8 mass %), “T7741P” (acid modification amount: 0.5 mass %), and “T7712SP” (acid modification amount: 0.3 mass %), and “EP961SP” (not modified) trade names of products by JSR CORPORATION were used as the ethylene-propylene copolymer (EPR), and “MH7020” (acid modification amount: 1.0 mass %) trade name of products by Mitsui Chemicals, Inc. was used as the ethylene-butene copolymer (EBR). As described above, those of the acid modification amount of 0.8 mass %, 0.5 mass %, and 0.3 mass % and with no modification were provided for EPR, and those of the acid modification amount of 1.0 mass % was provided as EBR and they were blended.

Molding products (test pieces) were prepared by using pellets of compositions obtained in Examples 1 to 4 and Comparative Examples 1 to 12 and physical properties thereof were measured and described in Tables 2-1 through 3-2. Among the physical properties, those requiring explanation for the measuring method are to be described below.

(1) Specific Gravity

Using a test specimen of 31 mm length, 6.35 mm width and 1.6 mm thickness, the specific gravity was measured according to ASTM-D792.

(2) Measurement for Water Absorption

After injection molding a dumbbell according to JIS No. 1 and dipping the same in water at 23° C. for 24 hours, it was taken out and the change coefficient of the weight by water absorption was measured.

(3) Melting Point, Glass Transition Temperature

The melting point was measured by using a differential scanning calorimeter, placing about 10 mg of a specimen in a not-sealed container made of aluminum, in a nitrogen gas stream (30 ml/min) at a temperature elevation rate of 10° C./min. For the glass transition temperature, a temperature at an intersection between a line extending a base line on the side of low temperature in a region where a discontinuous portion appears for the base line to the side of a high temperature, and a tangential line drawn at a point where the gradient of a curve for the stepwise change portion is at the maximum is defined as a glass transition temperature.

(4) Linear Expansion Coefficient

The linear expansion coefficient was measured according to JIS-K 7197 using a test specimen (10 mm length, 5 mm width, 3 mm thickness) obtained by preparing a flat plate of 3 mm thickness by injection molding and then cutting the plate.

(5) Measurement for Tensile Strength-Tensile Elongation:

JIS No. 1 dumbbell was injection molded and the tensile strength and the tensile elongation were measured according to JIS-K 7113 under the condition at 5 mm/min. The temperature condition for the tensile strength was set to 23° C., and the temperature condition for the tensile elongation was set to 23° C. and 120° C.

(6) Measurement for Bending Strength-Bending Modulus of Elasticity

A test specimen of 128 mm length, 12.7 mm width and 6.2 mm thickness was injection molded, and the bending strength and the bending modulus of elasticity were measured according to ASTM-D 790. The temperature condition was set to 23° C. and 120° C.

(7) Measurement for Notched Izod Impact Value

A test specimen of 62 mm length, 12.7 mm width and 3.2 mm thickness was injection molded and notched by a notch cutter, and the notched Izod impact strength was measured according to ASTM-D 256. The temperature condition was set to 23° C., −30° C., −40° C. In a case where the test specimen was not broken, it was indicated as “NB”.

(8) Measurement for Deflection Temperature Under Load (DTUL)

A test specimen of 128 mm length, 12.7 mm width and 6.2 mm thickness was injection molded and the deflection temperature under load was measured according to ASTM-D 648.

(9) Measurement for Hydrolysis Resistance

In an autoclave, a JIS No. 1 dumbbell was dipped in water at 150° C. for 500 hours. The tensile strength (S₁) of the taken out test specimen was measured according to JIS-K 7113. Further, the weight average molecular weight of the test specimen was calculated according to a GPC method (M₁). The tensile strength (S₀) and the weight average molecular weight (M₀) of the specimen before the test were also measured respectively and the tensile strength retention and the molecular weight retention were calculated according to the following equations:
Tensile strength retention (%)=(S₁/S₀)×100
Molecular weight retention (%)=(M₁/M₀)×100

(10) Measurement for Calcium Chloride Resistance

A JIS No. 1 dumbbell was injection molded and immersed in hot water at 100° C. for 22 hours as a pretreatment and then taken out. An aqueous 10% solution of calcium chloride was immersed in a gauze which was stuck on a test piece and heated in an oven at 80° C. for 2 hours. Then, the test specimen was taken out of the oven and cracks were confirmed at a normal temperature. The procedure described above was defined as one cycle, and repeated till 100 cycles.

(11) Melt Flow Rate (MFR)

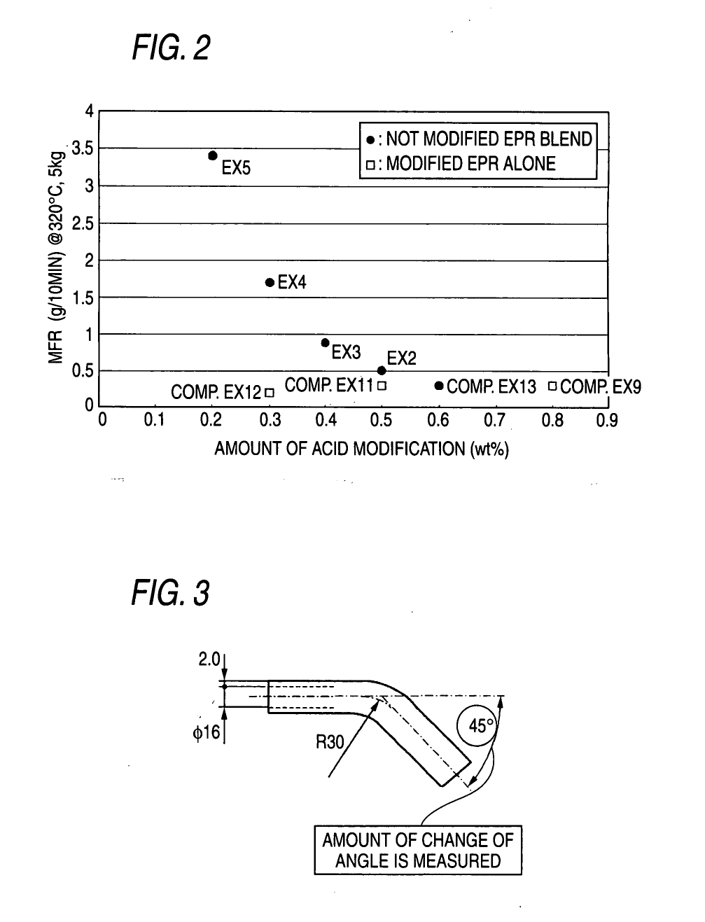

Measurement was conducted by a method according to ASTM-D1238 at a measuring temperature of 320° C. and under a load of 5000 g. Each of MFR for Examples 2 to 5 and Comparative Examples 9, 11, 12 and 13 is shown as a graph in FIG. 2. In FIG. 2, an example is abbreviated as “EX” and a comparative examples is abbreviated as “COMP. EX”

(12) Product Moldability

A pipe of a bellows-like shape having 16 mm of inner diameter, 1.0 mm of wall thickness, 2 mm of bellows amplitude, 5.5 mm of bellows pitch and 200 mm of length shown in FIG. 1B was corrugate molded by a φ50 extruder while setting the cylinder temperature from the material feed side to the exit side as 270 to 320° C. successively, a dice temperature at 320° C. and a speed of rotation to 50 rpm. As a result, it was evaluated as “O” for those that could be molded at a resin pressure in a range from 10 to 50 MPa without exerting large load on the extruder and evaluated as “X” for those with the pressure exceeding 50 MPa and exerting large load.

(13) Shape Retainability of Product

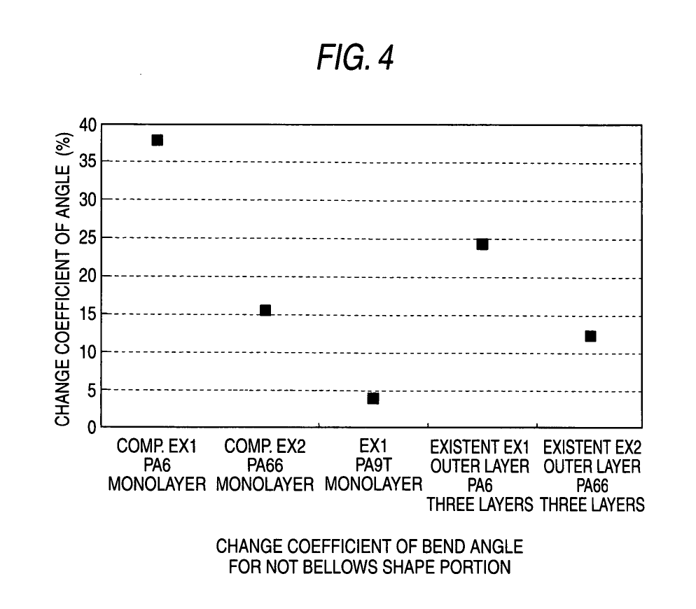

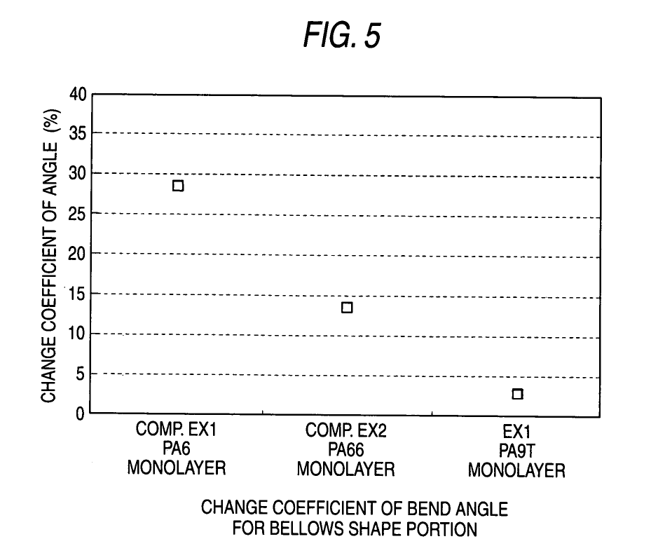

For five types, that is, Comparative Example 1, Comparative Example 2, Example 1, a conventional 3-layer structure having a polyamide 6 outer skin (existent example 1) and a conventional 3-layer structure having a polyamide 66 outer skin (existent example 2) wherein the conventional 3-layer structures are described in the paragraph of the background art, non-bellows shape pipes of 16 mm inner diameter, 2.0 mm wall thickness and 200 mm length shown in FIG. 1A were molded, heated at a temperature lower by 30° C. than the melting point of the thermoplastic polymer composition respectively and an intermediate portion in the longitudinal direction of the pipe was subjected to bending work at a 30 mm radius for the pipe center and at a bending angle of 45° as shown in FIG. 3, and allowed to cool at a room temperature. Then, after leaving in an atmosphere at a temperature of 50° C. and at a humidity of 95% RH for 90 hours (assuming the worst state during transportation of products) and then the returning angle from the bent angle 45° (change coefficient of the bend angle) was examined. For example, in a case where the bend angle 45° was returned by 15° into 30°, the change coefficient of the bend angle was determined as: (45°−30°)/45°×100=33.3%. The results are shown in FIG. 4. Further, for the bellows-shape pipe molded in (12) above (FIG. 1B) of the three types of Comparative Example 1, Comparative Example 2 and Example 1, the change coefficient of the bend angle was examined by leaving the products subjected to heating and bending work in the same manner under a stable temperature and stable humidity. The results are shown in FIG. 5.

From the results of Tables 2-1 though 3-2, and FIG. 2, FIG. 4 and FIG. 5, the followings can be recognized.

Since Comparative Example 1 (PA6) and Comparative Example 2 (PA66) are poor particularly in the low water absorption, the linear expansion coefficient, the hydrolysis resistance and the calcium chloride resistance, they cannot be constituted as a mono-layer water pipe. Further, they involve a drawback that the shape retainability is low and the change coefficient of the bend angle is large (FIG. 4, FIG. 5).

Since Comparative Example 3 (PPS) is poor particularly in the tensile elongation, the bending modulus of elasticity at high temperature and the notched Izod impact value at low temperature, it cannot be constituted as a mono-layer water pipe. Further, although it can be corrugation molded, the product cannot be put to bending work.

Since Comparative Example 4 (PA9T) is not blended with the polyolefin and, accordingly, poor particularly in the tensile elongation and the notched Izod impact value, it cannot be constituted as the mono-layer water pipe.

Since Comparative Examples 5 to 13 (PA9T+polyolefin) are different in either one or both of PA9T and polyolefin from those specified in the present invention, a portion of the characteristics is poor as shown below.

Since Comparative Example 5 and Comparative Example 8 have less amount of the terminal amino groups in PA9T, they are poor in the hydrolysis resistance.

Since Comparative Example 6 has a large amount of the acid modification in the polyolefin (EPR) and is not blended with the not modified polyolefin, MFR is small and the flowablility is poor and a bellows-shape pipe cannot be molded.

In Comparative Example 7, the type of the polyolefin is changed to EBR relative to Comparative Example 6 but MFR is small and the flowability is poor in the same manner.

Since Comparative Example 9 has a large amount of acid modification in the polyolefin (EPR) and is not blended with the not modified polyolefin, MFR is small and the flowability is poor and a bellows-shape pipe cannot be molded.

In Comparative Example 10, the type of the polyolefin is changed to EBR relative to Comparative Example 9 but MFR is small and the flowability is poor in the same manner.

In Comparative Example 11, while EPR is changed to that with less amount of the acid modification relative to Comparative Example 9, since the not modified polyolefin is not blended, MFR is small and the flowability is poor in the same manner (FIG. 2).

In Comparative Example 12, while EPR is changed to that with lesser amount of the acid modification relative to Comparative Example 9, since the not modified polyolefin is not blended, MFR is small and the flowability is poor in the same manner (FIG. 2). As described above, in a case where the polyolefin consists only of the acid-modified product, even when the amount of the acid modification thereof is lowered (for example, 0.2 to 0.5 mass % in the same manner), it can be seen that the viscosity is not lowered and the flowability and the moldability remain low as they are.

In Comparative Example 13, while a not modified polyolefin (EPR) is partially blended relative to Comparative Example 9, since the blending amount of the not modified EPR is small (the mass ratio of acid modified EPR and not modified EPR is 75:25), MFR is small and flowability is poor in the same manner.

On the contrary, it can be seen that Examples 1 to 5 are excellent in all of the low water absorption, the linear expansion coefficient, the tensile property, the bending property, the impact property, the hydrolysis resistance, the calcium chloride resistance, MFR (FIG. 2), the product moldability and the shape retainability (FIG. 4, FIG. 5) by blending of PA9T having a predetermined amount of terminal amino groups and a polyolefin mixed with a predetermined amount of a not-modified polyolefin. Accordingly, a water pipe 1 for use in automobiles of a complicate shape as shown, for example, in FIG. 1C can be molded. The water pipe 1 is molded with the thermoplastic polymer composition of the examples into a mono-layer structure, includes a straight shape portion with no corrugation (non-bellows shape portion) 2 and a bellows shape portion 3 (corrugated portion) and, further, includes a bend point 4 in the longitudinal direction by bending work after molding. The radius of bending at the center line of bending work is 1.5 times or more the outer diameter of the water pipe, and the bending angle is from 5 to 180°.

The present invention is not restricted to the examples described above but can be embodied by being modified properly within a range not departing the gist of the invention.

What is claimed is:

1. A water pipe for use in automobiles molded with a thermoplastic polymer composition mainly comprising a polyamide resin (I) and a polyolefin (II); in which
the polyamide resin (I) is a polyamide resin comprising a dicarboxylic acid unit (Ia) containing from 60 to 100 mol % of a terephthalic acid unit and a diamine unit (Ib) containing from 60 to 100 mol % of a 1,9-nonanediamine unit and a 2-methyl-1,8-octanediamine unit in which the molar ratio of the 1,9-nonanediamine unit and the 2-methyl-1,8-octanediamine unit is from 60:40 to 50:50;
the amount of the terminal amino groups of the polyamide resin (I) is 60 μmol/g or more and the amount of the terminal carboxyl groups of the polyamide resin (I) is 10 μmol/g or less;
the polyolefin (II) contains an acid modified polyolefin and a not acid modified polyolefin at a mass ratio of 80:20 to 20:80 and, as a result, the amount of acid modification is from 0.2 to 0.5 mass %; and
the mass ratio of the polyamide resin (I) and the polyolefin (II) is 90:10 to 70:30.

2. A water pipe for use in automobiles according to claim 1, wherein the polyolefin (II) is a mixture of
one or both of an acid-modified ethylene-propylene copolymer and an acid-modified ethylene-butene copolymer; and
one or both of a not acid-modified ethylene-propylene copolymer and a not acid-modified ethylene-butene copolymer.

3. A water pipe for use in automobiles according to claim 2, wherein the polyolefin (II) is a mixture of an acid-modified ethylene-propylene copolymer and a not acid-modified ethylene-propylene copolymer.

4. A water pipe for use in automobiles according to claim 1, wherein the water pipe for use in automobiles is molded with the thermoplastic polymer composition into a mono-layer structure and includes a bend point in the longitudinal direction by bending work after molding.

5. A water pipe for use in automobiles according to claim 2, wherein the water pipe for use in automobiles is molded with the thermoplastic polymer composition into a mono-layer structure and includes a bend point in the longitudinal direction by bending work after molding.
